(19) United States
(12) Patent Application Publication
(10) Pub. No.: US 2025/0303670 A1
(43) Pub. Date: Oct. 2, 2025

(54) RECYCABLE TEXTILE FOR PACKAGING, TRANSPORTING AND/OR STORING ITEMS

(71) Applicant: CONTEYOR INTERNATIONAL NV, Merelbeke (BE)

(72) Inventor: Petra VAN NECK, Merelbeke (BE)

(73) Assignee: CONTEYOR INTERNATIONAL NV, Merelbeke (BE)

(21) Appl. No.: 18/862,990

(22) PCT Filed: May 5, 2023
(86) PCT No.: PCT/EP2023/061980

§ 371 Date: Nov. 5, 2024

(30) Foreign Application Priority Data
May 6, 2022 (BE) BE2022/5344

(51) Int. Cl. B32B 5/26; B32B 5/02; B32B 5/06; D04H 1/492; D04H 1/498

(52) U.S. Cl. CPC B32B 5/273; B32B 5/022; B32B 5/028; B32B 5/067; D04H 1/492; D04H 1/498; B32B 2250/04; B32B 2250/20; B32B 2262/0261; B32B 2262/0276; B32B 2262/144; B32B 2262/156; B32B 2307/518; B32B 2307/54; B32B 2439/06; D10B 2331/02; D10B 2331/04

(57) ABSTRACT

The current invention relates to a textile suited for packaging, transporting and/or storing items, wherein said textile is a multilayered textile, said multilayered textile comprising a reinforcing middle part, a first outer nonwoven layer and a second outer nonwoven layer, wherein said reinforcing middle part is sandwiched between said first outer and said second outer nonwoven layer wherein said reinforcing middle part is comprised of two superimposed scrim layers, wherein each of said scrim layers has a weight between 50 to 100 g/m² and said textile has a total weight of between 250 and 350 g/m² as measured by EN 9073-1:1992. The current invention also relates to a container comprising aforementioned textile.

### FIELD OF THE INVENTION

The present invention relates to a textile and a container comprising said textile for packaging, transporting and/or storing items.

### BACKGROUND

Specialized forms of packaging, such as automotive parts packaging, require specialized packaging material as the parts may be heavy and fragile and include many electrical and electronic components. The parts are more prone to damage during transit, loading, and unloading and are in need of extra protection. As various parts have to travel long distances, they have to be packaged such that they reach the manufacturer in a safe-to-use condition.

As it is important that the textile from which the packaging is manufactured has a high strength to carry heavy items, textiles used for packaging often comprise a reinforcing layer, such as a scrim. However, said scrim layer is often rigid and not flexible enough to form packaging material. Furthermore, said scrim layer does not provide a soft surface and items coming into contact with this layer can easily become scratched or damaged. To avoid scratches or damage, said scrim layer is coated at both sides with Polyvinyl chloride (PVC). The PVC coating also reinforces the scrim. Consequently, the scrim layer can be made of more flexible fibers, increasing the flexibility of the textile. However, said PVC coating still forms a rather hard surface, causing regularly scratches or damage to the items. Additionally, the textile is not recyclable due to the PVC-coating on said scrim layer.

The present invention aims to resolve at least some of the problems and disadvantages mentioned above.

### SUMMARY OF THE INVENTION

The present invention and embodiments thereof serve to provide a solution to one or more of above-mentioned disadvantages. To this end, the present invention relates to a textile according to claim 1. More specifically, the invention relates to a textile suited for packaging, transporting and/or storing items, wherein said textile is a multilayered textile, said multilayered textile comprising a reinforcing middle part, a first outer nonwoven layer and a second outer nonwoven layer, wherein said reinforcing middle part is sandwiched between said first outer and said second outer nonwoven layer, wherein said reinforcing middle part is comprised of two superimposed scrim layers, wherein each of said scrim layers has a weight between 50 to 100 g/m² and said textile has a total weight of between 250 and 350 g/m² as measured by EN 9073-1:1992. Said textile is sufficiently strong to withhold the weight of heavy items and is sufficiently flexible and soft to be used a packaging material for packaging items prone to scratches. Preferred embodiments of the textile are shown in any of the claims 2 to 13.

In a second aspect, the present invention relates to a container according to claim 14. More particular, the present invention relates to a container comprising above-mentioned textile. Preferred embodiments of the container are shown in claim 15.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a schematic representation of a cross-sectional view of the textile according to an embodiment of the present invention.

FIGS. 2-4 show a container comprising a framework provided with multiple pouch systems fabricated using a textile according to an embodiment of the present invention.

### DETAILED DESCRIPTION OF THE INVENTION

The present invention concerns a textile and a container comprising said textile for packaging, transporting and/or storing items, especially heavy items prone to scratches.

### Definitions

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

“Cross direction” as used herein refers to the width direction, within the plane of the textile, that is perpendicular to the direction in which the textile is being produced by the machine.

“Machine direction” as used herein refers to the long direction within the plane of the textile, that is the direction in which the textile is being produced by the machine.

“A nonwoven” as used herein refers to an engineered fibrous assembly, primarily planar, which has been given a designed level of structural integrity by physical and/or chemical means, excluding weaving, knitting or paper making.

“Scrim” as used herein refers to a very open fabric, such as a netting, used as a support or a backing.

“Bonding” as used herein refers to conversion of a fibrous web into a nonwoven by chemical (adhesive/solvent) means or by physical (mechanical or thermal) means.

“Entanglement” as used herein refers to a method of forming a fabric by wrapping or knotting fibers in a web about each other by mechanical means, or by use of jets of pressurised air or water, so as to bond the fibers.

“Hydroentangling” or “a hydroentanglement process” as used herein refers to a method of bonding a web of fibers or filaments by entangling them by using high-pressure water jets. A preformed web is entangled by means of high pressure, columnar water jets. As the jets penetrate the web, fiber segments are carried by the highly turbulent fluid and become entangled on a semi-micro scale. In addition to bonding the web, which needs little or no additional binder, the process can also be used to impart a pattern to the web.

“Hydroentangled” as used herein refers to a web of fibers or filaments bonded by hydroentangling.

“Spunlaced fabric” as used herein refers to a hydroentangled fabric.

“Hydroentangled nonwoven” as used herein refers to a web bonded by hydroentanglement. It may additionally be bonded by other techniques.

“Fabric” as used herein refers to a sheet structure made from fibers, filaments or yarns.

“Fiber” as used herein refers to the basic threadlike structure from which nonwovens, yarns and textiles are made. It differs from a particle by having a length at least 100 times its width. Natural fibers are either of animal (wool, silk), vegetable (cotton, flax, jute) or mineral (asbestos) origin. Man-made fibers may be either polymers synthesised from chemical compounds (polyester, polypropylene, nylon, acrylic etc.) modified natural polymers (rayon, acetate) or mineral (glass).

“Filament” as used herein refers to a fiber of indefinite length.

“A yarn” as used herein refers to a continuous strand of fibers or filaments that are twisted together, to enable its conversion into a woven, knitted or braided fabric or textile.

“Tear resistance” as used herein refers to the force required to begin or to continue a tear in a fabric or textile under specific conditions.

“Tensile strength” as used herein refers to the maximum tensile stress expressed in force per unit cross sectional area of the unstrained specimen e.g. Newtons per square millimetre or Newtons/5 cm.

In a first aspect, the invention provides a textile suited for packaging, transporting and/or storing items, wherein said textile is a multilayered textile, said multilayered textile comprising a reinforcing middle part, a first outer nonwoven layer and a second outer nonwoven layer, wherein said reinforcing middle part is sandwiched between said first outer and said second outer nonwoven layer, wherein said reinforcing middle part is comprised of two superimposed scrim layers, wherein each of said scrim layers has a weight between 50 to 100 g/m² and said textile has a total weight of between 250 and 350 g/m² as measured by EN 9073-1:1992. In a preferred embodiment, the textile consists of a first outer nonwoven layer, two superimposed scrim layers and a second outer nonwoven layer, wherein said scrim layers are sandwiched between said first outer and said second outer nonwoven layer.

By providing a textile having a total weight of between 250 and 350 g/m², said textile having not one, but two superimposed scrim layers, each having a weight between 50 to 100 g/m², and having a first and a second outer nonwoven layer, a textile having sufficient strength and flexibility can be obtained, while simultaneously being suited for packaging, transporting and/or storing items prone to scratches. Said textile is sufficiently strong to withhold the weight of heavy items and is sufficiently flexible and soft to be used a packaging material for packaging items prone to scratches. The two superimposed scrim layers provide sufficient strength to make a PVC coating superfluous. Two superimposed scrim layers are surprisingly more flexible than one single scrim layer with a similar strength as the two superimposed scrim layers. The first and second outer nonwoven layers provide a softer surface compared to a PVC coating. In an embodiment, said scrim layers have a weight of 50 g/m². In an embodiment, said scrim layers have a weight of more than 50 g/m², such as 51 g/m², 52 g/m², 53 g/m², 54 g/m², 55 g/m², 56 g/m², 57 g/m², 58 g/m², 59 g/m², 60 g/m², 61 g/m², 62 g/m², 63 g/m², 64 g/m², 65 g/m², 66 g/m², 67 g/m², 68 g/m², 69 g/m², 70 g/m², 71 g/m², 72 g/m², 73 g/m², 74 g/m², 75 g/m², 76 g/m², 77 g/m², 78 g/m², 79 g/m², 80 g/m², 81 g/m², 82 g/m², 83 g/m², 84 g/m², 85 g/m², 86 g/m², 87 g/m², 88 g/m², 89 g/m², 90 g/m², 91 g/m², 92 g/m², 93 g/m², 94 g/m², 95 g/m², 96 g/m², 97 g/m², 98 g/m², 99 g/m² or 100 g/m². In a preferred embodiment, each scrim layer has a weight between 65 and 75 g/m², more preferably 70 g/m².

In an embodiment, the thickness of the textile is between 500 and 1500 μm, more preferably between 600 and 1400 μm, more preferably between 700 and 1300 μm, more preferably between 800 and 1200 μm, more preferably between 850 and 950 μm, such as 890 μm, as measured by ISO 9073-2:1996. A textile having such a thickness is sufficiently strong to carry heavy items, yet sufficiently flexible to be used as packaging material.

Yarn number is a measure of the fineness or size of a yarn, for instance expressed as mass per unit length, such as the weight in grams per 1000 meter (tex) or per 10000 meter (dtex). In an embodiment, the yarns in the scrim have a yarn number between 500 and 1500 dtex, more preferably between 800 and 1300 dtex, more preferably between 900 and 1200 dtex, such as 1100 dtex.

Since the emergence of multilayer packaging, the question of how to recycle this packaging has also been raised. The different layers are physically attached to each other and are therefore difficult to separate when recycling them. As a result, they have to be processed as a blend. However, these blends often consist of incompatible polymers that make the whole unmixable, resulting in negative mechanical properties.

In a preferred embodiment, the scrim layers form a reinforcing part made from polymeric fibers in an open mesh construction. In a preferred embodiment, said polymeric fibers are synthesised from chemical compounds. In an embodiment, said scrim layers are woven, preferably of a thermoplastic material. In a preferred embodiment said scrim layers are comprised of polyester (PES). In an embodiment, the nonwoven layers are comprised of PES/polyamide (PA) filaments. In a preferred embodiment, the textile consists of a first outer nonwoven layer, two scrim layers and a second outer nonwoven layer, said scrim layers being comprised of polyester (PES) and said nonwoven layers being comprised of PES/PA filaments. As the capital part of such a textile is made from PES, the different layers do not need to be separated before recycling the textile. As such, said textile is easily recyclable.

In an embodiment, the nonwoven layers are comprised of filaments with a thickness of at most 5 μm. Nonwoven layers comprised of said filaments are very light, resulting in a very soft textile. This is advantageous to avoid damage when packaging items prone to scratches in the textile of the invention. An example of suitable fibers are Evolon® fibers produced by Freudenberg.

In an embodiment, the nonwoven layers and scrim layers of the textile are bonded together by entangling fibers from the first outer nonwoven layer with fibers of the second outer nonwoven layer through the superimposed scrim layers to obtain complete fiber bonding between the layers, thereby preventing unwanted separation of the individual layers of the textile. This is advantageous because no adhesives are required to bond the nonwoven layers and the scrim layers, reducing the weight of the textile and simplifying recycling of the textile.

In an embodiment, bonding the layers together is achieved by subjecting the layers to a hydroentanglement process.

It is an established fact that the best nonwoven bonding technology that is available today to create fabrics that somewhat mimic the properties of woven fabrics, is the hydroentangled or spunlaced nonwoven fabric technology. The entanglement and the twisting of the fibers that occur in the case of spunlace fabrics is somewhat similar to the twist in the yarns of the woven fabrics and thus, spunlace fabrics provide the best drape characteristics among the nonwoven fabrics. Compared to drylaid nonwovens, the spunlaid technology eliminates the costly transformation of polymers into staple fibers. In this process, synthetic polymers in chip or flake form are extruded. The molten polymers, predominantly Polypropylene, Polyester or Polyethylene, are first spun into endless filaments by spinnerets. Underneath the spinnerets the filaments are cooled and stretched by air and are laid down on an apron in a continuous process. The web at this stage is unbonded and lacks any strength or integrity. Typically, the spunlaid webs are bonded by using thermal calendaring rolls by fusing the fibers at intermediate points to create a stronger fabric. The cross section of the filaments and the polymer blend composition can be varied as in traditional melting spinning. Several bicomponent filament configurations are commercially available in the marketplace. The most common being a core/sheath configuration spinneret die design that provides continuous spunlaid filaments with a higher melting polymer, such as polyester or nylon 66, in the core and a lower melting polymer, such as nylon 6 or polyethylene, on the sheath. The stronger polymer in the core contributes to the mechanical properties, whereas the polymer in the sheath contributes to bonding using thermal calendering and provides tie points among filaments by the applied heat and pressure. In a preferred embodiment, the nonwoven layers are comprised of PES/PA filaments.

In an embodiment, each of said scrim layers comprises two sets of polymeric fibers, wherein said sets of fibers are arranged transversely to each other, said sets of fibers thereby delineating open squares, each of said squares having a dimension of preferably at least 2 mm×2 mm and at most 5 mm×5 mm. In an embodiment, each of said squares has a dimension of 2 mm×2 mm. In an embodiment, each of said squares has a dimension of 3 mm×3 mm. In an embodiment, each of said squares has a dimension of 4 mm×4 mm. In an embodiment, each of said squares has a dimension of 5 mm×5 mm. Said dimensions being defined as the smallest perpendicular distance between two adjacent fibers in the machine direction and the smallest perpendicular distance between two adjacent fibers in the cross-direction.

By providing scrim layers with squares having such a diameter, the fibers from the first outer nonwoven layer are able to pass through the squares of the scrim layers and entangle with fibers of the second outer nonwoven layer to obtain complete fiber bonding, thereby preventing separation of the individual layers of the textile. In case said squares would have smaller dimensions, the fibers from the first and second nonwoven layer might not be able to pass through the scrims layers and entangle, causing the various layers to fall apart. On the other hand, squares with too big dimensions might result in scrim layers with insufficient physical properties, resulting in damage or tearing of the fabric when carrying heavy loads.

In an embodiment, squares of a first scrim layer of said superimposed scrim layers are superimposed on squares of a second scrim layer of said superimposed scrim layers, with an alignment error of at most 0.8 mm in a direction of the fibers delineating the squares. In an embodiment, said alignment error is 0.8 mm. In an embodiment, said alignment error is less than 0.8 mm, such as 0.7 mm, 0.6 mm, 0.5 mm, 0.4 mm, 0.3 mm, 0.2 mm, 0.1 mm or less than 0.1 mm. Said alignment error can be in the direction of the first or the second set of polymeric fibers forming the squares of the scrim layers.

By superimposing the squares of the first scrim layer and the second scrim layer with such a maximal alignment error, the open mesh structure provided by the squares of the two scrim layers remains large enough to allow the fibers from the first and second nonwoven layer to pass through and entangle with each other.

Stretch technology is a process for shaping a fabric or textile. This causes the polymer chains in the textile to be aligned in a well-defined direction. This is done by applying a force that pulls the polymer molecules in a certain direction, after which the molecules are held in that state. In a biaxial stretching technology, this process is performed in two directions in the textile. This can be done sequentially or simultaneously. The “machine direction” is the direction in which the textile moves through the machine from start to finish. The “cross direction” is the direction perpendicular to the machine direction. Textiles that are only stretched in the machine direction have great longitudinal strength, but tend to tear.

In a preferred embodiment, the textile is formed using a biaxial stretching technology, and thus the textile includes a machine direction and a transverse direction. A biaxial stretching technology provides greater tear strength than if the textile were stretched only in the machine direction.

The tear strength of the fabric refers to its resistance to tearing force. Usually textile tears when it is snagged by a sharp object and the immediate small puncture is converted into a long rip. This is probably the most common type of strength failure, so testing textile tear strength is very important.

In an embodiment, the tear strength of the textile of the current invention is between 100 and 200 N, preferably between 120 and 180 N, more preferably between 150 and 170 N, such as 161 N, in the machine direction and between 50 and 150 N, preferably between 70 and 130 N, more preferably between 90 and 110 N, such as 99 N in the cross direction as measured by EN 13937-1:2000. In an embodiment, the tear strength of the textile of the current invention is between 100 and 200 N, preferably between 120 and 180 N, more preferably between 150 and 170 N, such as 161 N, in the machine direction and between 50 and 150 N, preferably between 70 and 130 N, more preferably between 90 and 110 N, such as 99 N in the cross direction as measured by EN 13937-2:2000. In an embodiment, the tear strength of the textile of the current invention is between 100 and 200 N, preferably between 120 and 180 N, more preferably between 150 and 170 N, such as 161 N, in the machine direction and between 50 and 150 N, preferably between 70 and 130 N, more preferably between 90 and 110 N, such as 99 N in the cross direction as measured by EN 13937-3:2000. In an embodiment, the tear strength of the textile of the current invention is between 100 and 200 N, preferably between 120 and 180 N, more preferably between 150 and 170 N, such as 161 N, in the machine direction and between 50 and 150 N, preferably between 70 and 130 N, more preferably between 90 and 110 N, such as 99 N in the cross direction as measured by EN 13937-4:2000.

A textile with such a tear strength is suitable for packaging heavier materials with sharp edges.

Elongation at break, also known as fracture strain, is the ratio between changed length and initial length after breakage of the test specimen. It expresses the capability of fibers to resist changes of shape without crack formation. In an embodiment, the elongation at break in both directions is between 20% and 30%, more preferably between 22% and 26%, such as 24%, as measured by EN 13934-1:2013.

In an embodiment, the tensile strength in both directions is between 1500 and 2500 N/5 cm as measured by EN 13934-1:2013. In an embodiment, the tensile strength in the machine direction is between 1500 and 2500 N/5 cm, preferably between 1600 and 2400 N/5 cm, more preferably between 1700 and 2300 N/5 cm, more preferably between 1800 and 2200 N/5 cm, more preferably between 1800 and 1900 N/5 cm, such as 1849 N/5 cm. In an embodiment, the tensile strength in the cross direction is between 1500 and 2500 N/5 cm, preferably between 1500 and 2300 N/5 cm, more preferably between 1600 and 2100 N/5 cm, more preferably between 1700 and 1900 N/5 cm, more preferably between 1700 and 1800 N/5 cm, such as 1737 N/5 cm.

In a second aspect, the invention provides a container, wherein the container comprises above-mentioned textile. Said container has all the beneficial properties of the textile of which it is made, such as sufficient strength and flexibility, while simultaneously being soft enough to package items prone to scratches.

Often parts are of an odd shape and/or size and it is important that there is maximum utilization of available space so that travel costs are reduced.

In an embodiment, the container comprises a pouch system, wherein the textile forms individual pouches suspended in a framework.

In an embodiment, hanging of the pouch system from the framework is done by means of a profile provided with a hook element. The purpose of this is to ensure that the materials are quickly and easily packed and removed from the device. Since the textile according to the present invention is flexible, these pouches are foldable to save space and consequently transportation costs when unloaded. The pouches of the pouch system can have any size. In an embodiment, the depth of the pouch is located between 500 mm and 4000 mm, preferably between 600 mm and 3000 mm, even more preferably between 800 mm and 2500 mm. In an embodiment, the width of the pouch is located between 500 mm and 5000 mm, preferably located between 800 mm and 3500 mm, even more preferably between 1000 mm and 3000 mm. In an embodiment, the height of the pouch is located between 500 mm and 4000 mm, preferably located between 600 mm and 3000 mm, even more preferably between 800 mm and 2500 mm.

In an embodiment, the framework is provided with multiple pouch systems. Each pouch system hereby comprises the textile according to the present invention suspended by means of a loop system from a profile. The loop system is manufactured from the textile itself.

Thus, an envelope-shaped pouch system is created, in which materials can be stored. In one embodiment, one side of the material will form a loop system for one profile, and the other, opposite side of the material will form a second loop system, which goes around a second profile. Thus, a pouch system is formed that will behave independently of the other pouch systems present in the frame.

Each of these profiles is provided at both ends with a hook element which then serves to suspend the profile and pouch system from two opposite support rods of a framework.

The framework is further provided with vertical rods that define the size of the framework. The framework may also be provided with wheels, to allow easy transportation of the packaged materials (for example, to and from the aircraft).

The framework may also be provided with closure means such as a rubber band attached to two overlying support rods of the framework. When the framework is transported, it may also be provided with one or more dust-resistant, removable covers that partially or completely encompass the framework.

The textile according to the present invention can be used for frameworks and profiles of different length and size, and is therefore multifunctional.

### DESCRIPTION OF FIGURES

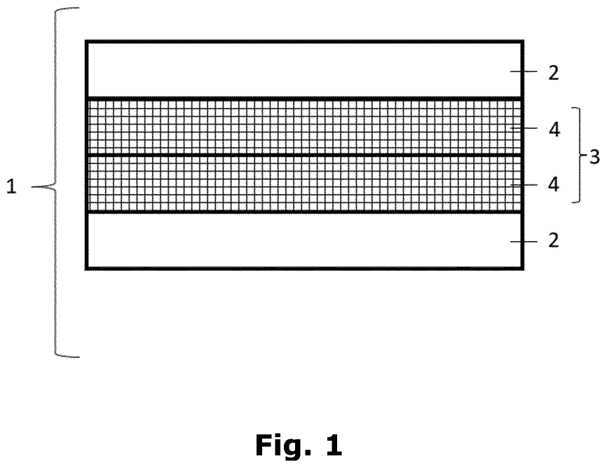

FIG. 1 shows a construction of a textile 1 according to a preferred embodiment of the present invention. The textile 1 is suitable for the manufacturing of a packaging material for packaging, transporting and or storing heavy items prone to scratches. The multilayered textile 1 is constructed as follows: two nonwoven layers as outer layers 2 and between these two outer layers 2 is an internal reinforcing part 3 made of two superimposed scrim layers 4. Each of said scrim layers 4 has a weight of approximately 70 g/m² and the textile 1 has a total weight of approximately 300 g/m² as measured by EN 9073-1:1992. The thickness of the textile is approximately 890 μm as measured by ISO 9073-2:1996. By providing a textile 1 having a total weight of approximately 300 g/m², said textile 1 having not one, but two superimposed scrim layers 4, each having a weight of approximately 70 g/m², and having a first and a second outer nonwoven layer 2, a textile 1 having sufficient strength and flexibility can be obtained, while simultaneously being suited for packaging heavy items prone to scratches. The yarns in the scrim layers 4 have a yarn number of 1100 dtex. The scrim layers 4 are made of polyester (PES) and the nonwoven layers 2 are comprised of PES/polyamide filaments with a thickness of at most 5 μm (not shown). As the capital part of the textile 1 is made from PES, the different layers 2,4 do not need to be separated before recycling the textile 1. As such, the textile 1 is easily recyclable. Nonwoven layers 2 comprised of said filaments are very light, resulting in a very soft textile 1. This is advantageous to avoid damage when packaging items prone to scratches in the textile of the invention. The nonwoven layers 2 and scrim layers 4 of the textile 1 are bonded together by entangling fibers from the first outer nonwoven layer 2 with fibers of the second outer nonwoven layer 2 through the superimposed scrim layers 4 to obtain complete fiber bonding between the layers 2,4, thereby preventing unwanted separation of the individual layers of the textile 1. This is achieved by subjecting the layers to a hydroentanglement process. Each of the scrim layers 4 comprises two sets of PES fibers, said sets of fibers being arranged transversely to each other, said sets of fibers thereby delineating squares, each of said squares having a dimension of approximately 3 mm×3 mm. By providing scrim layers 4 with squares having such dimensions, the fibers from the first outer nonwoven layer are able to pass through the squares of the scrim layers and entangle with fibers of the second outer nonwoven layer to obtain complete fiber bonding, thereby preventing separation of the individual layers of the textile. In case said squares would have smaller dimensions, the fibers from the first and second outer nonwoven layer 2 might not be able to pass through the scrims layers 4 and entangle, causing the various layers to fall apart. On the other hand, squares with too big dimensions might result in scrim layers with insufficient physical properties, resulting in damage or tearing of the textile when carrying heavy loads. The squares of the first scrim layer of said superimposed scrim layers are superimposed on squares of the second scrim layer of said superimposed scrim layers, with an alignment error of at most 0.8 mm in a direction of the fibers delineating the squares. The tear strength of the textile 1 of the current invention is 161 N in the machine direction and 99 N in the cross direction as measured by EN 13937-1:2000. A textile 1 with such a tear strength is suitable for packaging heavier materials with sharp edges. The elongation at break of the textile in both directions is 24%, as measured by EN 13934-1:2013. The tensile strength of the textile in the machine direction is 1849 N/5 cm and 1737 N/5 cm in the cross direction.

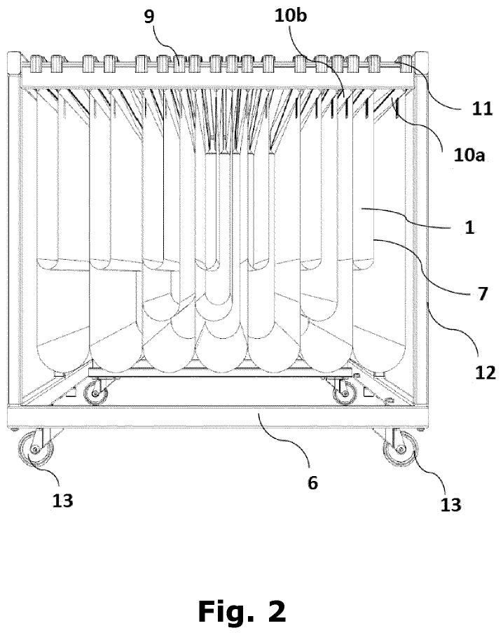

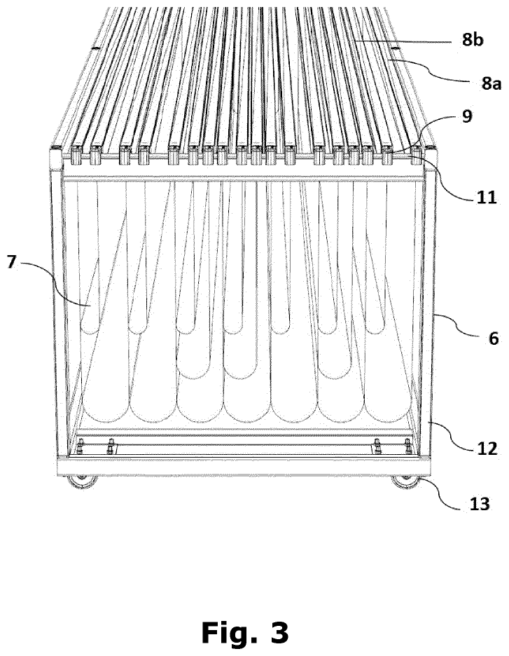

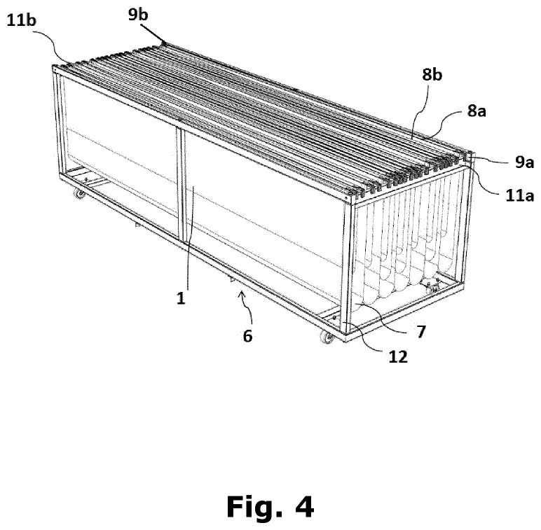

FIGS. 2-4 show a container comprising a framework 6 provided with multiple pouch systems 7 according to the present invention. The textile 1 according to the present invention forms separate pouches 7 which are suspended in a framework 6. In an embodiment, hanging of the pouch system 7 from the framework 6 is done by means of a profile 8a, 8b provided with a hook element 9. Each pouch system 7 comprises the textile according to the present invention 1 which is suspended by means of a loop system 10 from a profile 8. The loop system 10 is manufactured from the textile 1 itself.

Thus, an envelope-shaped pouch system 7 is created, in which items can be stored. In an embodiment, one side of the textile 1 will form a loop system 10a for one profile 8a, and the other, opposite side of the textile 1 will form a second loop system 10b, which goes around a second profile 8b. Thus, a pouch system 7 is formed which will behave independently of the other pouch systems 7 present in the frame.

In the embodiments shown in FIGS. 2 to 4, the pouch system comprises a plurality of pouches, where one profile 8a is provided with one loop system 10a comprising the multilayer textile according to the present invention 1 which splits into 2 or more pouches, each of different size (depth, width). Each of the disaggregated materials will then be connected by means of a separate loop system 10b to a second profile 8b located either immediately adjacent to the first profile 8a, or at a distance therefrom, where between the first and second profiles there are one or more profiles which also form part of the pouch system and are connected by a loop system. In this way, a multiple pouch system is formed, with pouches of different sizes and capacities.

In another embodiment, not shown, the formed pouch systems will include two profiles (8a, 8b), each following the other. Thus, a single pouch system is created.

Each of these profiles 8 is provided at both ends with a hook element 9a, 9b which then serves to suspend profile 8 and pouch system 7 from two opposite support rods 11a, 11b of a framework 6.

The framework 6 is further provided with vertical rods 12 that define the size of the framework. The framework 6 may also be provided with wheels 13, to allow easy transport of the packaged items (for example, to and from the aircraft).

The present invention is in no way limited to the embodiments shown in the figures.

1. A textile suited for packaging, transporting and/or storing items, wherein said textile is a multilayered textile, said multilayered textile comprising:
a reinforcing middle part,
a first outer nonwoven layer and a second outer nonwoven layer,
wherein said reinforcing middle part is sandwiched between said first outer and said second outer nonwoven layer, and said reinforcing middle part includes two superimposed scrim layers, and
wherein each of said scrim layers has a weight between 50 to 100 g/m² and said textile has a total weight of between 250 and 350 g/m² as measured by EN 9073-1:1992.

2. The textile according to claim 1, wherein each of said scrim layers comprises two sets of polymeric fibers, wherein said sets of fibers are arranged transversely to each other, said sets of fibers thereby delineating open squares, each of said squares having preferably a dimension of at least 2 mm×2 mm and at most 5 mm×5 mm.

3. The textile according to claim 2, wherein squares of a first scrim layer of said superimposed scrim layers are superimposed on squares of a second scrim layer of said superimposed scrim layers, with an alignment error of at most 0.8 mm in a direction of the fibers delineating the squares.

4. The textile according to claim 1, wherein said textile comprises a machine direction and a cross direction and wherein the tensile strength in both directions is between 1500 and 2500 N/5 cm as measured by EN 13934-1:2013.

5. The textile according to claim 1, wherein said textile comprises a machine direction and a cross direction and wherein the tear strength is between 100 and 200 N in the machine direction and between 50 and 150 N in the cross direction as measured by EN 13937:2000.

6. The textile according to claim 1, wherein said textile comprises a machine direction and a cross direction and wherein the elongation at break in both directions is between 20% and 30% as measured by EN 13934-1:2013.

7. The textile according to claim 1, wherein the nonwoven layers are comprised of filaments with a thickness of at most 5 μm.

8. The textile according to claim 1, wherein the nonwoven layers and scrim layers of the textile are bonded together by entangling fibers from the first outer nonwoven layer with fibers of the second outer nonwoven layer through the superimposed scrim layers to obtain complete fiber bonding between the layers, thereby preventing separation of the individual layers of the textile.

9. The textile according to claim 8, wherein bonding the layers together is achieved by subjecting the layers to a hydroentanglement process.

10. The textile according to claim 1, wherein the nonwoven layers are comprised of polyester/polyamide (PES/PA) filaments.

11. The textile according to claim 1, wherein the thickness of the textile is between 500 and 1500 μm as measured by ISO 9073-2:1996.

12. The textile according to claim 1, wherein said scrim layers are comprised of polyester (PES).

13. The textile according to claim 1, wherein said textile consists of a first outer nonwoven layer, two superimposed scrim layers and a second outer nonwoven layer, wherein said scrim layers are sandwiched between said first outer and said second outer nonwoven layer.

14. A container, wherein the container comprises the textile according to claim 1.

15. The container according to claim 14, wherein the container comprises a pouch system, wherein the textile forms individual pouches suspended in a framework.
